(19) United States
(12) Patent Application Publication
(10) Pub. No.: US 2017/0293830 A1
(43) Pub. Date: Oct. 12, 2017

(54) INTEGRATED ELECTRONIC PAPER

(71) Applicant: HAZEN PAPER COMPANY, HOLYOKE, MA (US)

(72) Inventor: JOHN HAZEN, SOUTH HADLEY, MA (US)

(21) Appl. No.: 15/480,858

(22) Filed: Apr. 6, 2017

Related U.S. Application Data
(60) Provisional application No. 62/319,344, filed on Apr. 7, 2016.

(51) Int. Cl. G06K 19/02; G06K 19/16; G06K 19/077

(52) U.S. Cl. CPC G06K 19/025; G06K 19/07773; G06K 19/07722; G06K 19/16

(57) ABSTRACT

The present invention is directed to an integrated electronic substrate a substrate, a radio frequency identification device embedded in the substrate; a metallic deposition disposed on the substrate; the metallic deposition is in electronic communication with the radio frequency identification device to enhance the effective range and power of the radio frequency identification device.

### CROSS-REFERENCE TO RELATED APPLICATIONS

This application claims the benefit of U.S. Provisional Application Ser. No. 62/319,344 filed on Apr. 7, 2016, which is herein incorporated by reference in its entirety.

### FIELD OF THE INVENTION

This invention relates, generally, to integrated electronic paper, and, in particular, to electronic paper that utilize integrated metallic depositions, including decorative metallic depositions, to further enhance the communicability and functionality of the electronic paper.

### BACKGROUND OF THE INVENTION

Holographic printing and imaging has been used throughout the packaging and advertisement industries, as well as being used extensively to enhance the security of documents and papers. Typically, in paper or film substrate applications, holographic imaging is accomplished by depositing a thin metallic layer onto a transfer film, and applying this film to a laminate construction. Removal of the transfer film then leaves the metallic design, including holographic designs, on the laminate construction, or single sheet substrate. Holographic images may also be directly printed upon a substrate, including a laminated substrate.

While the visual and security appeals of holographic depositions have been widely appreciated, there is a trend to add another level of data intelligence and communication to single sheet paper or paper/film laminate constructions. Such ‘electronic paper’ typically employs passive or even active radio frequency identification (‘RFID’) devices embedded into the material of the electronic paper.

Thus, known electronic paper often involves interleaving RFID devices between layers of a paper/film substrate laminate construction, while other methods involve imbedding the RFID device in the fibers of a paper substrate itself. These known electronic paper assemblies, however, suffer in both quality and performance due to the limited communicability and functionality of the RFID's (or, like devices) embedded therein.

It is therefore one object of the present invention to provide electronic paper that utilizes integrated metallic depositions, including holographic metallic depositions, to further enhance the communicability and functionality of the electronic paper.

### SUMMARY OF THE INVENTION

The integrated electronic paper of the present invention seeks to utilize holographic designs, images and depositions to further enhance the operability and functionality of data/communication electronics that are embedded within the integrated paper.

In particular, the present invention seeks to utilize all or a portion of a metallic holographic design to act as a portion of the electronic circuitry of a RFID assembly.

### BRIEF DESCRIPTION OF THE DRAWINGS

FIG. 1 illustrates one embodiment of a known, active RFID assembly.

FIG. 2 illustrates one embodiment of a known, passive RFID assembly.

FIG. 3 illustrates one embodiment of an electronic paper having a holographic design being utilized as part of the embedded RFID device.

### DETAILED DESCRIPTION OF THE PREFERRED EMBODIMENTS

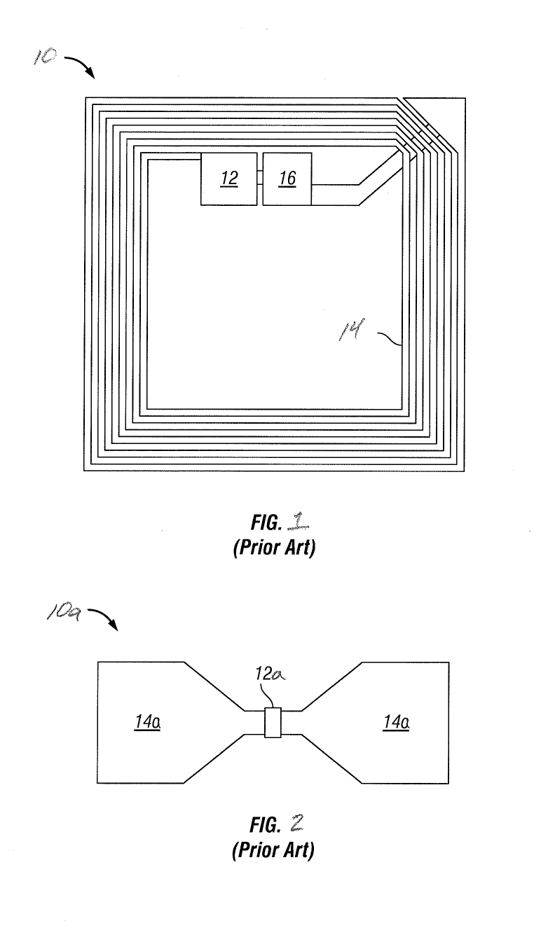

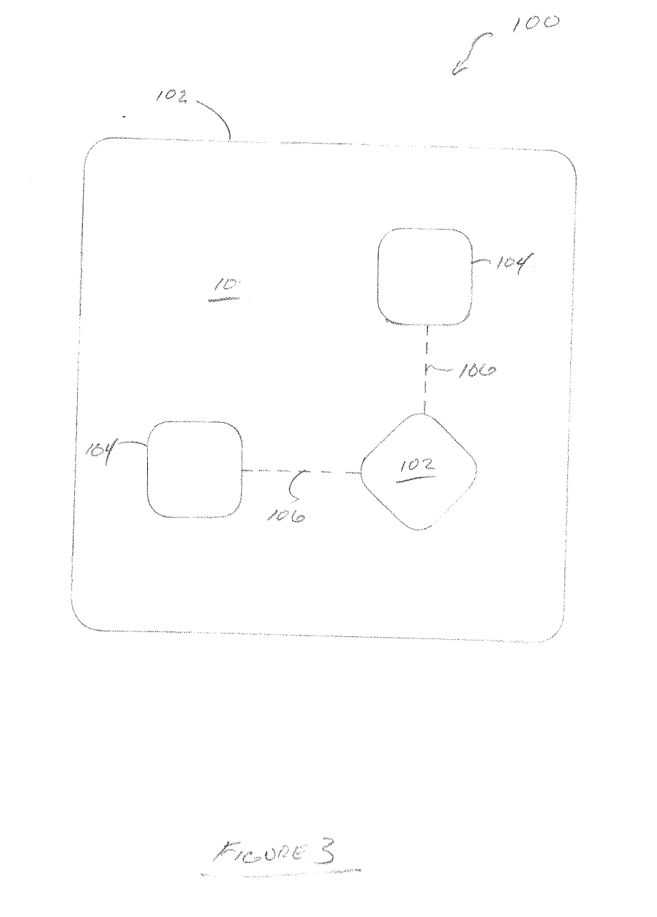

FIG. 1 illustrates one embodiment of an active RFID assembly 10. As is known, such active RFID assemblies typically include a microcontroller 12 and a battery device 16, coupled to an antenna 14. For its part, FIG. 2 illustrates one embodiment of a known, passive RFID assembly 10a. As shown in FIG. 2, known passive RFID assemblies typically include a microprocessor 12a, as well as an antenna loop 14a.

As will be appreciated, whether the RFID assembly is an active assembly, or a passive assembly, each of the RFID assemblies include an antenna which is itself formed by the deposition of a thin, metallic conductor, chosen on a case-by-case basis to accommodate the specific technology of a given RFID assembly.

As discussed previously, RFID assemblies of all types are now being integrated into paper constructs, including single sheet paper and laminate paper constructions, to form what is known as electronic or intelligent paper. The RFID devices in such electronic paper constructs have a capability to actively, or passively, respond to incoming electromagnetic waves, and in the case of active RFID assemblies, to generate their own outgoing communication owing to the incorporated battery of active RFID devices.

FIG. 3 illustrates an integrated electronic paper assembly 100, according to one embodiment of the present invention. As shown in FIG. 3, the electronic paper 100 includes a substrate 102, which may be either a single sheet of paper or other substrate material, or a laminate construction, without departing from the broader aspects of the present invention.

The electronic paper 100 further includes an embedded RFID device 102, which may be either an active RFID assembly or a passive RFID assembly. Also shown in FIG. 3, the electronic paper 102 supports one or more holographic depositions/designs 104, which are in electrical communication with the RFID assembly 102 via one or more electrical conductors 106.

A further review of FIG. 3 shows how the electronic paper 102 utilizes the metallic depositions of the holographic designs 104 to define or further support an antenna of the RFID assembly 102.

It will therefore be readily appreciated that by utilizing the metallic depositions of the holographic designs to act as the antenna, or a portion thereof, of the integrated RFID assembly, the electronic paper 100 of the present invention can increase both the effective range and power of the RFID assembly 102.

Moreover, as holographic designs are already utilized in many applications, the ability of the present invention to harness the metallic qualities of the holographic designs to further enhance the functionality of an embedded RFID design, greatly reduces the amount of additional metallic depositions needed to create the antenna element of an integrated RFID assembly.

Depending on the specific use and capabilities desired, the present invention contemplates depositing the metallic film to create a holographic image in a manner that would essentially replicate the chosen antenna design of any integrated RFID assembly. Thus, the present invention envisions either utilizing a nominal holographic deposition as part of the RFID antenna, or alternatively, to utilize a dedicated holographic deposition (such as in the form of an antenna spiral 14, as shown in FIG. 1) in combination with a nominal holographic deposition, in order to further enhance the communicability and functionality of an electron paper assembly.

What is claimed:

1. An integrated electronic substrate comprising:
a substrate;
a radio frequency identification device embedded in said substrate;
a metallic deposition disposed on said substrate;
wherein said metallic deposition is in electronic communication with said radio frequency identification device.

2. The integrated electronic substrate in claim 1, wherein:
said metallic deposition comprising a holographic design.

3. The integrated electronic substrate in claim 1, wherein:
said integrated electronic substrate responds to incoming electronic waves.

4. The integrated electronic substrate in claim 1, wherein:
said radio frequency identification device comprising a microprocessor and an antenna.

5. The integrated electronic substrate in claim 4, wherein:
said radio frequency identification device further comprising a battery;
wherein said radio frequency identification device generates outgoing communication in response to incoming electronic waves.

6. The integrated electronic substrate in claim 4, wherein:
said antenna is a metallic deposition comprising holographic design.

7. The integrated electronic substrate in claim 4, wherein:
said metallic deposition enhances the effective range and power of said radio frequency identification device.

8. The integrated electronic substrate in claim 1, wherein:
said substrate is a single sheet paper.

9. The integrated electronic substrate in claim 1, wherein:
said substrate is a laminate paper construction.

10. An integrated electronic substrate comprising:
a substrate;
a radio frequency identification device embedded in said substrate; said radio frequency identification device comprising a microprocessor and an antenna;
a holographic design comprising a metallic deposition disposed on said substrate;
wherein said metallic deposition is in electronic communication with said radio frequency identification device;
wherein said integrated electronic substrate responds to incoming electronic waves.

11. A method of producing an integrated electronic substrate, said method comprising the steps of:
embedding a radio frequency identification device in a substrate;
disposing a metallic deposition on said substrate;
electronically connecting said radio frequency identification device and said metallic deposition.

12. The method of producing an integrated electronic substrate of claim 11, wherein said metallic deposition comprising a holographic design.

13. The method of producing an integrated electronic substrate of claim 11, wherein said integrated electronic substrate responds to incoming electronic waves.

14. The method of producing an integrated electronic substrate of claim 11, wherein
said radio frequency identification device comprising a microprocessor, and an antenna.

15. The method of producing an integrated electronic substrate of claim 14, further comprising steps of:
equipping said radio frequency identification device with a battery;
wherein said radio frequency identification device generates outgoing communication in response to incoming electronic waves.
